(19) United States
(12) Patent Application Publication
(10) Pub. No.: US 2016/0244124 A1
(43) Pub. Date: Aug. 25, 2016

(54) AXLE SLIDER BLOCK WITH INTEGRATED CHAIN ADJUSTMENT MEANS

(71) Applicant: Charlie R. Hon, Yorba Linda, CA (US)

(72) Inventor: Charlie R. Hon, Yorba Linda, CA (US)

(21) Appl. No.: 14/626,056

(22) Filed: Feb. 19, 2015

(51) Int. Cl. B62M 9/16

(52) U.S. Cl. CPC B62M 9/16

(57) ABSTRACT

An axle slider block with integrated chain adjustment means is provided. The device comprises an exterior block for being received by a proximate opening on a motorcycle swing arm, the exterior block defining a recess for receiving the interior block which travels on a longitudinal axis relative the exterior block and which has an axle bore hole through the axle of a rear wheel is secured.

### FIELD OF THE INVENTION

This invention relates to a device for aligning the rear wheel of a motorcycle and more particularly related to aligning or repositioning the rear wheel of a motorcycle when adjusting the play in a chain or belt driving the rear wheel.

### BACKGROUND

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Motorcycles typically comprise a chassis (or frame), engine, and front and rear wheels. Motorcycles also typically include axles that couple the rear wheels to a swing arm.

Adjusters on frames and swing arms for belt and chain driven motorcycles exist in the prior art and are needed for adjusting tension in the belt or chain while maintaining the alignment of the rear wheel of the motorcycle. Aligning the rear wheel properly has been a concern of operators of motorcycles since their inception. Generally, in order to adjust the axle position, a nut, mounted on a threaded stud which is connected to the axle, must be turned to either loosen the threaded stud or tighten it. The driven rear wheel is, in most cases, suspended by a swing arm of various dimensions which is affixed to the frame. In modern motorcycle, the swing arm generally provides a proximate opening and hollow cavity to receive an axle slider block. In order to adjust tension on the drive chain of the motorcycle, the rear wheel sprocket and axle are moved horizontally depending upon the type of adjustment desired.

However, current axle slider blocks are comprised of inefficient and unnecessary components which do allow efficient alignment of a rear wheel and chain together. There exists a need in the art for more a more efficient axle slider block with chain adjustment means.

### SUMMARY

From the foregoing discussion, it should be apparent that a need exists for a more efficient axle slider block with chain adjustment means for enabling quicker and chain adjustment and rear wheel alignment.

The present invention has been developed in response to the present state of the art, and in particular, in response to the problems and needs in the art that have not yet been fully solved by currently available apparatus. Accordingly, the present invention provides an axle block slider for a motorcycle, the axel block slider comprising: an interior block having a central axle bore hole to accept through passage of an axle of a motorcycle, the exterior block also defining a horizontally-elongated recess; an exterior block for insertion into a proximate opening and cavity of a swing arm, the exterior block having two attachment points for mating with a motorcycle accessory, the exterior block defining a recess for receiving the interior block, the exterior block further defining an aperture for receiving in part an actuator, the aperture oriented lengthwise orthogonally to the horizontal-elongated recess, the exterior block slidable longitudinally across the interior block; and an actuator for adjusting the length of a bolt partially inserted through the aperture into the horizontally-elongated recess, the bolt for engaging an exterior surface of the exterior block, the bolt adjusting a longitudinal position of the exterior block relative to the interior block.

The motorcycle accessory may comprises a rear stand hook. The interior block may comprises two guide rails which protrude outwardly from a main body of the interior block upon which the exterior block travels longitudinally. The axle slider block of claim 1, wherein the axle bore hole defined by the interior block has a diameter of between 0.5 inches and 3 inches.

The interior block further comprise, in some embodiments, a cantilevered portion jutting laterally from a remainder of the interior block, the cantilevered portion defining the aperture.

The axial rotation of the actuator may adjustably regulate a distance between the axle and a distal of the exterior block. The exterior block comprises in some embodiment a proximal end and distal end.

In various embodiments, the housing is configured to integrate on a brake side and a sprocket side of the motorcycle. The actuator may comprise a threaded bolt.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a forward perspective view of an axle slider block in accordance with the present invention;

FIG. 2 illustrates a forward perspective view of an axle slider block in accordance with the present invention;

FIG. 3 illustrates a side perspective view of an axle slider block in accordance with the present invention;

FIG. 4 illustrates a rearward perspective view of an axle slider block in accordance with the present invention;

FIG. 5 illustrates a lower side perspective view of a motorcycle with affixed swing arm in accordance with the prior art; and

FIG. 6 illustrates a side perspective view of an axle slider block in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Any flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

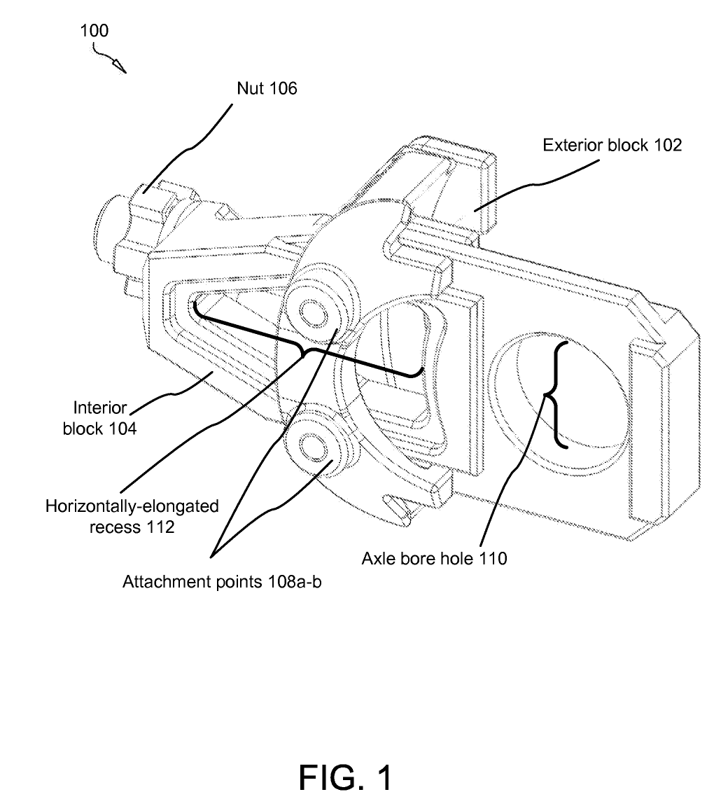

FIG. 1 illustrates a forward perspective view of an axle slider block 100 in accordance with the present invention. The axle slider block 100 comprises an exterior block 102, an interior block 104, a nut 106, attachment points 108a-b, an axle bore hole 110, and a horizontally-elongated recess 112.

The exterior block 102 comprises a concave or oblong metal alloy or metal component which is insertable and affixable into a proximate opening of a swing arm. In various embodiments, the exterior block 102 is printed, machined, molded or otherwise fabricated to comprise a single solid piece.

The exterior block 102 defines a hollow recess traversing the exterior block through its longitudinal axis and open at both ends for receiving the interior block 104. The interior block 104 travels longitudinally within the exterior block 102.

The interior block 102 defines a horizontally-elongated recess open at both ends across a lateral axis for reducing the weight of the interior block 104. In various embodiments, the threaded actuator bolt in inserted into the horizontally-elongated recess where the bolt engages the exterior block 102. In other embodiments, the bolt is adjustable to obstruct an interior lateral opening of the horizontally-elongated recess and abut the exterior block 102.

The interior block 104 further defines an axle bore hole 110 traversing the interior block 104 laterally for receiving the axle of a motorcycle. The bore hole 110 may be between 0.25 inches and 4 inches in diameter.

The attachment points 108a-b may comprise (or define) threaded holes on the recessed into the exterior surface of the exterior bloc 102 and disposed to mate with a plurality of bolts forming part of an auxiliary motorcycle implement such as rear stand hook.

As referenced, an axle slider block 100 (or system) integrates with a motorcycle to facilitate adjustment of a chain and alignment of a rear wheel driven by the chain (or belt), such as adjusting the slack on the chain. The axle slider block 100 may be configured to facilitate access and preparation of the chain to adjust the slack on the chain. The axle slider block 100 may form a unitary piece with the swing arm. The device 100 may be detachably affixed to or built into a cycle swing arm for enabling facilitated chain adjustment and alignment of the rear wheel.

The integrated positioning of the present invention along a longitudinal axis of the swing arm helps retain the wheel and chain in the proper alignment, both during operation and maintenance.

Additionally, the axle slider block 100 provides attachment points for enabling attachment of auxiliary members such as rear stand or rear stand hook, which allows the rear section of the cycle to be raised with a stand during adjustment of the chain, or any maintenance. The axle slider block 100 has sufficient structural integrity to support the weight of the cycle during operation. Those skilled in the art will recognize that adjusting the chain requires adjusting both sides of the rear axle. Therefore, the axle slider block 100 may comprise both left and right embodiments configured to integrate on a brake side and a sprocket side of the cycle. Beneficially, the axle slider block 100 is simplified, as fewer tools and setup procedures are required for adjusting, or changing the chain on a cycle. Also, the functionality of the cycle is increased.

In some embodiments, an elongated adjustment member or actuator having a bolt like shape, extends outwardly from the rear end of the interior block 104. The actuator enable longitudinal adjustment of an actuator bolt and consequently the rear axle itself secured by the axle bore hole 110.

The interior block 104 may be bored to enable the actuator and/or actuator bolt to at least partially pass through from the interior block 104 into the horizontally-elongated recess 112 or in front of an opening the horizontally-elongated recess 112. The nut 106 is threaded to move inward and outward a terminal end of the actuator bolt when the nut 106 is rotated axially. A tool, such as an Allen wrench, ratchet, screw driver, and the like may be inserted through an opening recessed into the terminal end of the actuator bolt efficacious for tightening or loosening the chain.

In some embodiments, the exterior block 102 includes one or more attachment points 108a-b that provide a surface for attachment of auxiliary members or motorcycle accessories. The exterior block 102 may define the attachment point 108a-b of a size and dimension to receive the bolts of auxiliary members. The auxiliary member may include a swing arm slider that forms a barrier that extends out from the left or right side of the exterior block 102, and helps protect the device 100, the rear axle, and the chain from damage. The swing arm slider may remain attached to the axle slider block 100 during operation of the cycle. Another possible auxiliary member may include a rear stand hook that extends approximately a few inches outward or beneath the exterior block 102.

The rear stand hook mounts to the mounting portion, thus forming a stable foundation. A stand can be used to support the rear section of the cycle busing the rear stand hook as a pillar of support. The rear section of the cycle may be raised into this position with the rear stand hook during adjustment of the chain, or any other cycle maintenance. The rear stand hook and the attached housing have sufficient structural integrity to support the weight of the cycle in this manner.

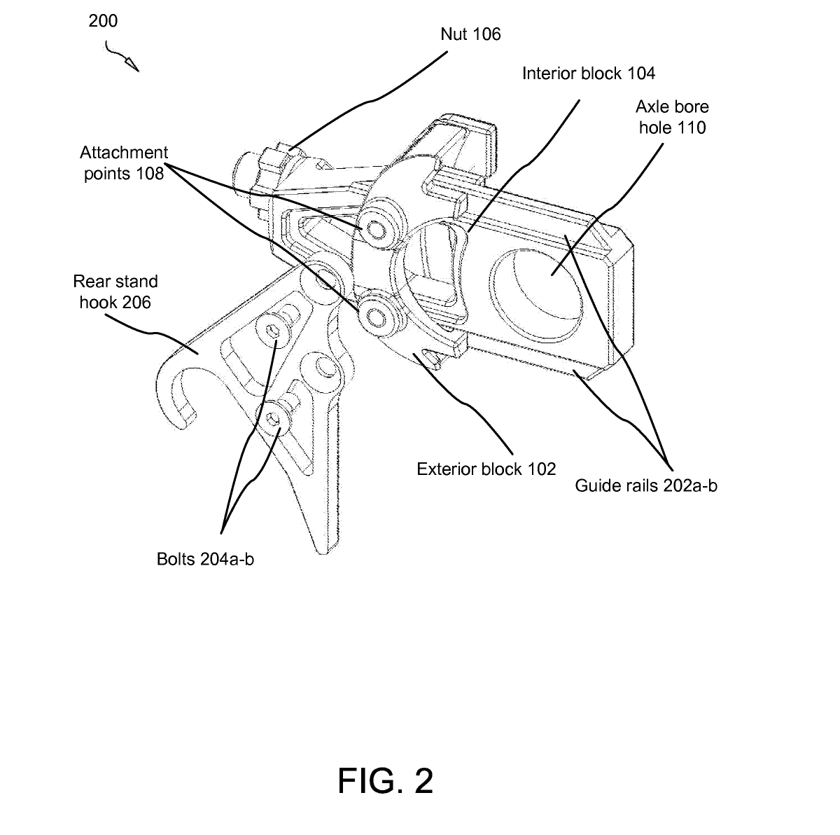

FIG. 2 illustrates a forward perspective view of an axle slider block 200 in accordance with the present invention. The device 200 comprises an exterior block 102, an interior block 104 having guide rails 202a-b, a nut 106, attachment points 108, and a rear stand hook 206 comprising bolts 204a-b.

In various embodiments, the interior block 104 comprises two guide rails 202a-b which protrude outwardly from the main body of the interior block 104 on the device's 200 z-axis. The x-axis constitutes the longitudinal axis and the y-axis the lateral axis. The guide rails 202a-b may comprise ridges upon which the exterior block 102 travels. In other embodiments, the guide rails 202a-b are recessed into the interior block 102 and may be channels or tracks for receiving the exterior block 102.

The rear stand hook 206 as shown for securing the device 200 on a stand.

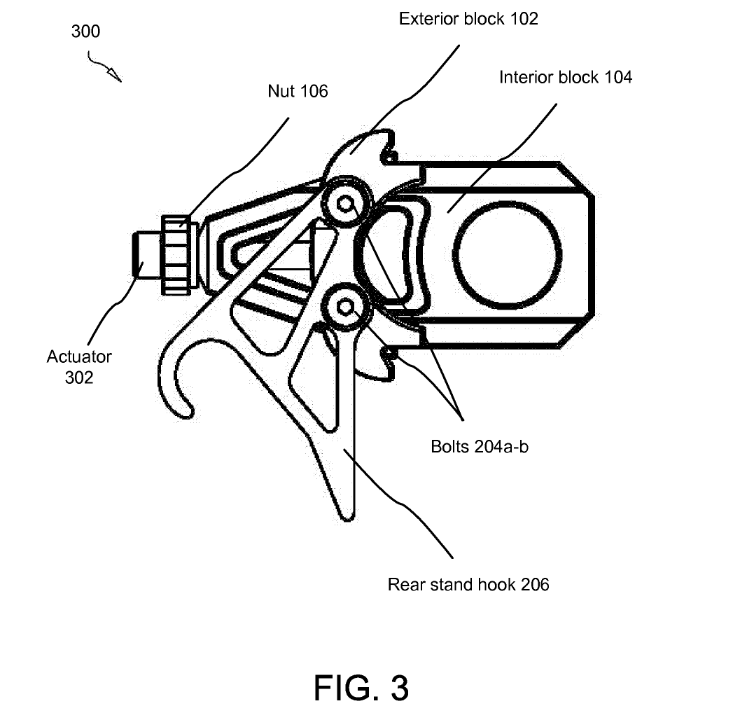

FIG. 3 illustrates a side perspective view of an axle slider block 300 in accordance with the present invention.

The actuator 302 in various embodiments comprises the bolt, nut and other components of the adjuster which regulates the position of the interior block 104 relative to the exterior block 102.

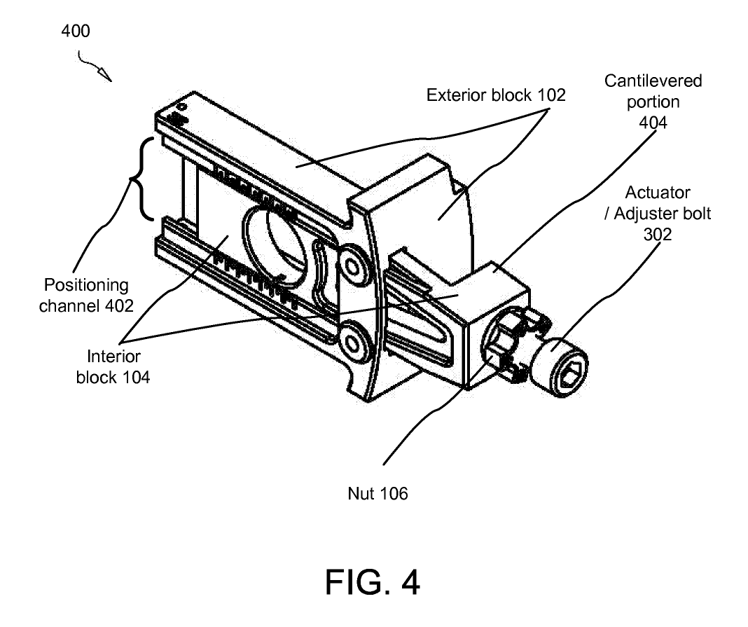

FIG. 4 illustrates a rearward perspective view of an axle slider block 400 in accordance with the present invention. The axle slider block 400 comprises an exterior block 102, an interior block 104 having a positioning channel 402 and cantilevered portion 404, and an actuator 302.

The exterior block 102 may define a positioning channel 402 within which the interior block 102 travels laterally in response to adjustment of the actuator 302 bolt. In those embodiments, the exterior block 102 comprises an outer sleeve partially enveloping the interior block 104. The exterior block 102 and its outer sleeve are removably inserted into a cavity via a proximate opening on the terminal end of a swing arm or frame of the motorcycle.

In various embodiments, the interior block 104 comprises a cantilevered portion 404 which juts out laterally from the main body of the interior block 104. In is through the cantilevered portion 404 that the aperture is bored, drilled or defined through which the actuator 302 bolt is threadably inserted.

The actuator 302 bolt, when adjusted, abuts and pushes longitudinally the interior block (and thus the axle of the rear wheel of the motorcycle) away from the exterior block 102 (and swing arm secured to it), thus adjusting the alignment of the rear wheel of the motorcycle.

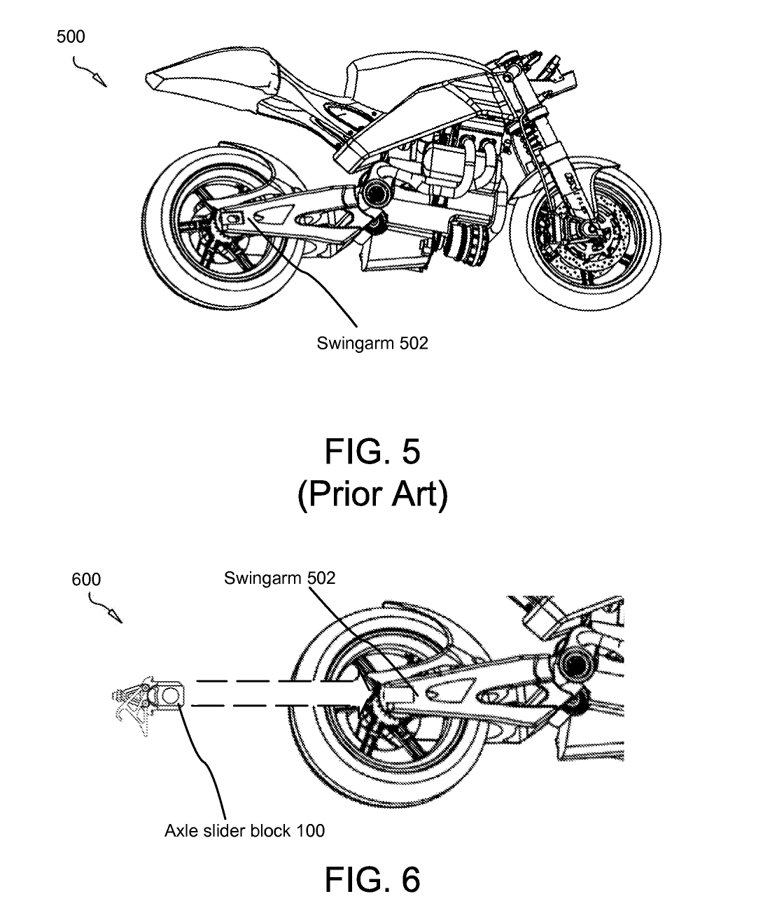

FIG. 5 illustrates a lower side perspective view of a motorcycle 500 with affixed swing arm in accordance with the prior art. The swing arm 502 is shown which is affixed to the frame or chassis of the motorcycle.

FIG. 6 illustrates a side perspective view of an axle slider block 100 in accordance with the present invention.

The arrow shows the direction that the axle slide block 100 may be directed forward to dispose in a cavity defined by the swing arm.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An axle block slider for a motorcycle, the axel block slider comprising:
an interior block having a central axle bore hole to accept through passage of an axle of a motorcycle, the exterior block also defining a horizontally-elongated recess;
an exterior block for insertion into a proximate opening and cavity of a swing arm, the exterior block having two attachment points for mating with a motorcycle accessory, the exterior block defining a recess for receiving the interior block, the exterior block further defining an aperture for receiving in part an actuator, the aperture oriented lengthwise orthogonally to the horizontal-elongated recess, the exterior block slidable longitudinally across the interior block; and
an actuator for adjusting the length of a bolt partially inserted through the aperture into the horizontally-elongated recess, the bolt for engaging an exterior surface of the exterior block, the bolt adjusting a longitudinal position of the exterior block relative to the interior block.

2. The axle slider block of claim 1, wherein the motorcycle accessory comprises a rear stand hook.

3. The axle slider block of claim 1, wherein the interior block comprises two guide rails with protrude outwardly from a main body of the interior block upon which the exterior block travels longitudinally.

4. The axle slider block of claim 1, wherein the axle bore hole defined by the interior block has a diameter of between 0.5 inches and 3 inches;

5. The axle slide block of claim 1, wherein the interior block further comprises a cantilevered portion jutting laterally from a remainder of the interior block, the cantilevered portion defining the aperture.

6. The axle slide block of claim 1, wherein axial rotation of the actuator adjustably regulates a distance between the axle and a distal of the exterior block.

7. The axle slide block of claim 1, wherein the exterior block comprises a proximal end and distal end.

8. The axle slide block of claim 1, wherein the housing is configured to integrate on a brake side and a sprocket side of the motorcycle.

9. The axle slide block of claim 1, wherein the actuator comprises a threaded bolt.
